(19) United States
(12) Patent Application Publication
(10) Pub. No.: US 2026/0162209 A1
(43) Pub. Date: Jun. 11, 2026

(54) GRAPHICS PROCESSING UNIT INCLUDING SHADER MODULE

(71) Applicant: Samsung Electronics Co., Ltd., Suwon-si (KR)

(72) Inventors: Junmo Park, Suwon-si (KR); Wilson Wai Lun Fung, Austin, TX (US); Zhenhong Liu, Austin, TX (US)

(21) Appl. No.: 19/413,932

(22) Filed: Dec. 9, 2025

Related U.S. Application Data
(60) Provisional application No. 63/730,185, filed on Dec. 10, 2024.

(30) Foreign Application Priority Data
Jun. 13, 2025 (KR) 10-2025-0078041

(51) Int. Cl. G06T 1/20; G06F 9/48; G06T 15/00

(52) U.S. Cl. CPC G06T 1/20; G06F 9/4881; G06T 15/005

(57) ABSTRACT

A graphics processing unit (GPU) includes a GPU memory including a first memory and a second memory and a plurality of shader arrays each including a plurality of shader modules. Each of the shader modules includes a data address generation circuit configured to update a search pattern for at least one piece of input data by using pipeline information stored in the first memory and, based on the search pattern that has been updated, generate at least one memory address corresponding to the input data, a data loading circuit configured to load the input data from the second memory based on the memory address and the pipeline information, a controller configured to schedule at least one instruction for performing a graphics pipeline, and a processing circuit configured to perform shading on the input data.

### CROSS-REFERENCE TO RELATED APPLICATIONS

This application is based on and claims priority under 35 U.S.C. § 119 to Korean Patent Application No. 10-2025-0078041, filed on Jun. 13, 2025, in the Korean Intellectual Property Office and U.S. Provisional Application No. 63/730,185, filed on Dec. 10, 2024, in the U.S. Patent and Trademark Office, the disclosures of which are incorporated by reference herein in their entireties.

### BACKGROUND

GPUs serve to render graphics data on computing devices. In general, GPUs convert graphics data corresponding to two-dimensional (2D) or three-dimensional (3D) objects into 2D pixel representations, thereby generating frames for display. Computing devices may include personal computers (PCs), laptop computers, video game consoles, and embedded devices, such as smartphones, tablet devices, and wearable devices. Because of relatively low arithmetic processing capability and high power consumption, embedded devices, such as smartphones, tablet devices, and wearable devices, struggle to achieve the same graphics processing performance as workstations, such as PCs, laptop computers, and video game consoles, which have sufficient memory capacity and processing power. However, with the recent widespread use of portable devices, such as smartphones and tablet devices, the frequency of users playing games or watching content, such as movies and dramas, on smartphones or tablet devices has rapidly increased.

### SUMMARY

In line with users'demand of portable devices and other electronic devices using GPUs, extensive research may be conducted to increase the performance and processing efficiency of GPUs in embedded devices. In particular, shader modules (e.g., vertex shaders) performing a graphics pipeline may be introduced as a software component (e.g., UberFetchShader) to process input data in various formats without recompilation. However, in this case, as too many pieces of code and/or instructions may be added to prevent recompilation due to a change in an input data format, compilation time may rapidly increase, and degradation of device performance (e.g., poor Codegen quality) may occur due to excessive overload.

The present disclosure provides a graphics processing unit (GPU) for preventing recompilation due to the format change of input data through simple code and/or instructions by performing component loading on input data in various formats, which is input to a graphics pipeline based on a hardware component, an operating method of the GPU, and an electronic device.

In some aspects, the present disclosure provides a GPU including: a GPU memory that includes a first memory and a second memory; and a plurality of shader arrays each including a plurality of shader modules, where each of the plurality of shader modules includes a data address generation circuit configured to update a search pattern for at least one piece of input data by using pipeline information stored in the first memory and, based on the search pattern that has been updated, generate at least one memory address corresponding to the at least one piece of input data, a data loading circuit configured to load the at least one piece of input data from the second memory based on the at least one memory address and the pipeline information, a controller configured to schedule at least one instruction for performing a graphics pipeline, and a processing circuit configured to perform shading on the at least one piece of input data.

In some aspects, the present disclosure provides an operating method of a GPU. The operating method includes identifying whether a format of at least one piece of input data is changed based on pipeline information and operation (OP) code, updating a search pattern for the at least one piece of input data by using the pipeline information when the format of the at least one piece of input data has been changed, loading the at least one piece of input data based on search pattern that has been updated, and performing a shading process on the at least one piece of input data that has been loaded.

In some aspects, the present disclosure provides an electronic device including: a memory; and a processor including a shader module configured to perform a graphics pipeline, where the shader module is configured to update a search pattern for at least one piece of input data by using pipeline information, the at least one piece of input data being input to the graphics pipeline, load the at least one piece of input data in multiple cycles based on the search pattern that has been updated, pad the at least one piece of input data according to a predetermined method, based on the pipeline information, and perform shading on the at least one piece of input data that has been padded.

### BRIEF DESCRIPTION OF THE DRAWINGS

FIG. 1 is a block diagram of an example of a system-on-chip (SoC).

FIG. 2A is a block diagram illustrating an example of a graphics pipeline for image processing.

FIG. 2B illustrates example components performing a graphics pipeline.

FIG. 3 is a block diagram illustrating an example of a shader array.

FIG. 4 is a diagram illustrating the structure of an example of a shader array.

FIG. 5 is a diagram of an example of a shader module.

FIG. 6 is a flowchart of an example operating method of a graphics processing unit (GPU).

FIG. 7 shows examples of instructions based on pipeline information.

FIG. 8 is a block diagram of an example of an electronic device.

FIG. 9 illustrates an example of an electronic device.

### DETAILED DESCRIPTION

Hereinafter, implementations are described with reference to the accompanying drawings.

In the drawings, like reference numerals denote like elements, and redundant descriptions thereof will be omitted.

Hereinafter, a graphics processing unit 100 may be referred to as a GPU 100.

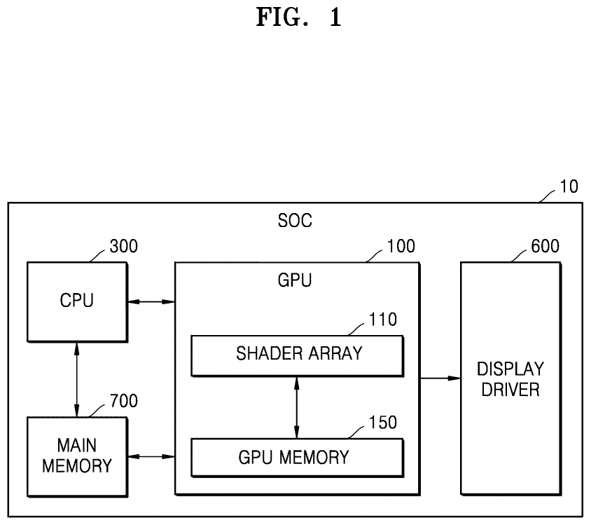

FIG. 1 is a block diagram of a system-on-chip (SoC) according to some implementations.

Specifically, FIG. 1 shows an example of an SoC 10 including the GPU 100, according to the inventive concept. The SoC 10 may include the GPU 100, a central processing unit (CPU) 300, a display driver 600, and a main memory 700.

The SoC 10 may correspond to a computing device capable of processing and displaying two-dimensional (2D) or three-dimensional (3D) graphics data. The SoC 10 may include a television (TV) (e.g., a digital TV or a smart TV), a personal computer (PC), a desktop computer, a laptop computer, a computer workstation, a tablet PC, a video game platform (or a video game console), a server, or a portable electronic device.

The portable electronic device may include a mobile phone, a smartphone, a personal digital assistant (PDA), an enterprise digital assistant (EDA), a digital still camera, a digital video camera, a portable multimedia player (PMP), a personal navigation device or portable navigation device (PND), a mobile Internet device (MID), a wearable computer, an Internet of things (IoT) device, an Internet of everything (IoE) device, or an e-book.

The CPU 300 may generally control operations of the SoC 10. The CPU 300 may include a plurality of cores. The CPU 300 may process a task as an arithmetic unit. In some implementations, the CPU 300 may receive a task processing request and a task from the outside. In response to the task processing request, he CPU 300 may perform a scheduling operation to allocate at least one of the cores to the task and transmit the task to the allocated core. A plurality of cores may process a task received from the CPU 300.

The CPU 300 may process or execute programs and/or data stored in a memory. For example, the CPU 300 may control the functions of the components of the SoC 10 by executing the programs stored in the main memory 700. For example, applications executed by the CPU 300 may include graphics rendering instructions. The graphics rendering instructions may be related to a graphics application programming interface (API). The graphics API may refer to Open Graphics Library (OpenGL(R)) API, Open Graphics Library for Embedded Systems (Open GL ES) API, DirectX API, Renderscript API, WebGL API, or Open VG(R) API. The CPU 300 may transmit a graphics rendering command to the GPU 100 through a bus.

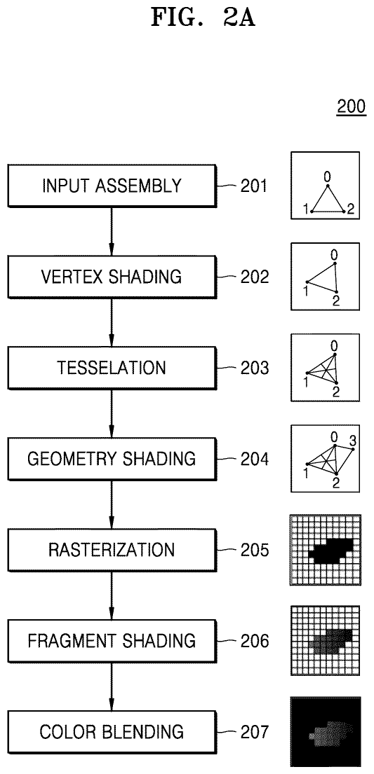

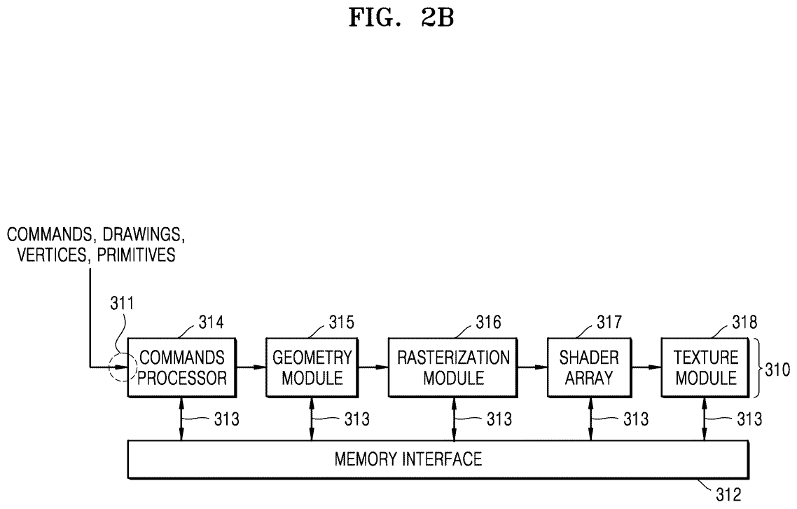

The GPU 100 may be hardware that controls the graphics processing function of the SoC 10. The GPU 100 may be a dedicated graphics processor that performs various versions and types of graphics pipelines, such as Open Graphic(s) Library (OpenGL), DirectX, and Compute Unified Device Architecture (CUDA), and may be implemented to perform a 3D graphics pipeline (e.g., 200 in FIG. 2A) in order to render 3D objects in a 3D image into a 2D image for display.

The GPU 100 may be controlled by a driver thereof and a graphics API executed by the CPU 300 that runs an operating system (OS).

The GPU 100 may include a software component (e.g., UberFetchShader) for processing input data in various formats without recompilation in a graphics pipeline. However, in this case, as too many pieces of code and/or instructions are added to prevent recompilation due to a change in an input data format, compilation time rapidly increases, and degradation of device performance (e.g., poor Codegen quality) occurs due to excessive overload.

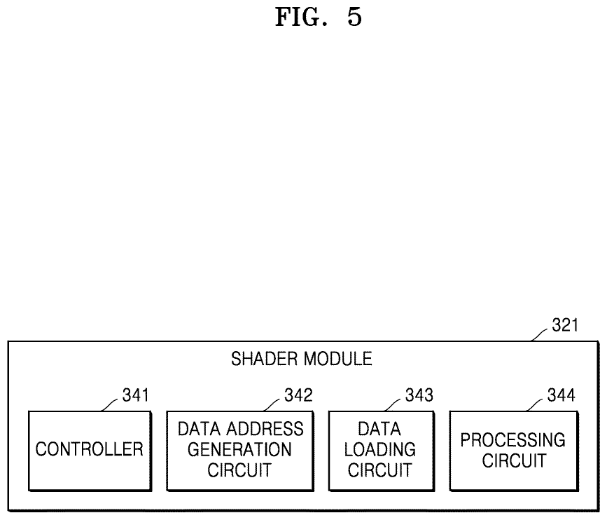

Therefore, according to some implementations, the GPU 100 may control offload processing for a graphics pipeline corresponding to the graphics API and the driver. Here, “offload processing” may refer to that a hardware component (e.g., a shader module 321 of FIG. 5) performs a specific function (e.g., loading of at least one piece of input data from a GPU memory 150) performed by a software component (e.g., UberFetchShader). In this case, the GPU 100 may relax the alignment requirements (e.g., address alignment conditions) of operation code (OP code) for loading at least one piece of input data to comply with Vulkan requirements, and a compiler no longer needs to generate a custom code path used to handle a case where the address alignment conditions are not met. Instead, the GPU 100 may determine/update an appropriate search pattern based on pipeline information by using the shader module 321 and may load at least one piece of input data based on the search pattern. Here, a minimum alignment condition (i.e., an address alignment condition) may refer to a condition in which the address of input data should be aligned to a minimum size (e.g., element size or dword). For example, 8_8_8_8 format may satisfy the minimum alignment condition when aligned to an element size (i.e., 32 bits). For example, when the address of input data to be processed in a graphics pipeline does not satisfy (or guarantee) the minimum alignment condition, the GPU 100 may control a shader module (a hardware component, e.g., the shader module 321 of FIG. 5) to load (perform offload processing as multi-cycle loading on) the input data (e.g., component data) to be processed in the graphics pipeline from the GPU memory 150.

As described above, according to some implementations, the GPU 100 may prevent recompilation due to the format change of input data by performing offload processing of the operation of a software component to the operation of a hardware component and may simultaneously decrease compilation time and prevent excessive overload through simple code/instructions.

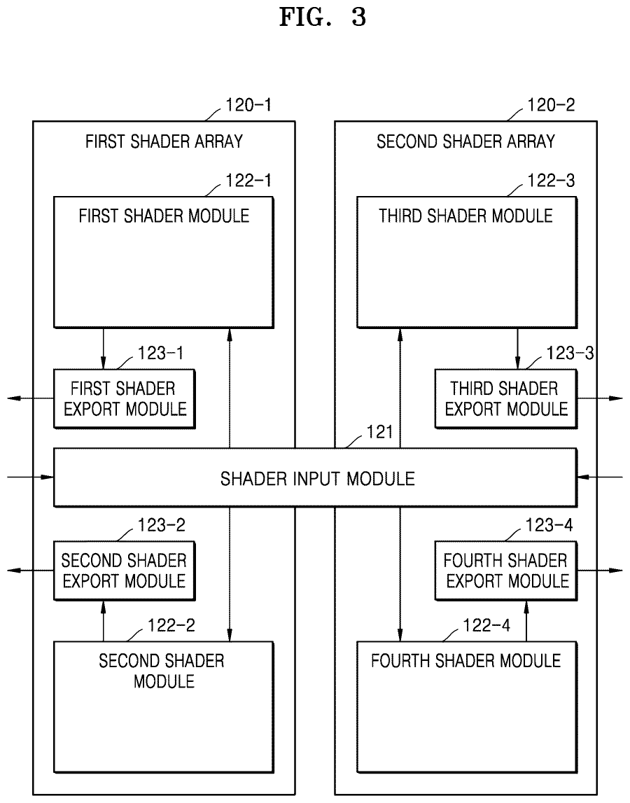

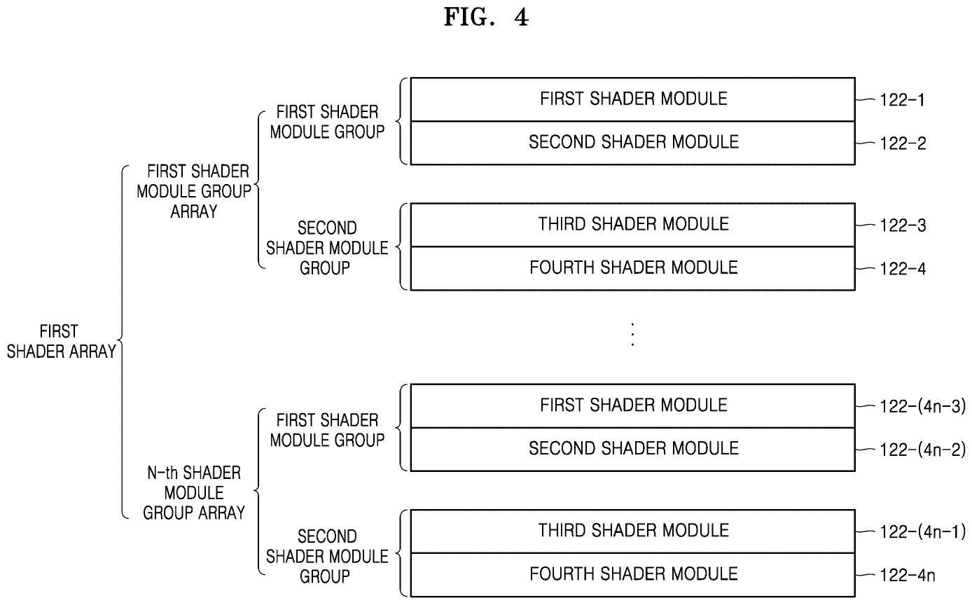

A shader array 110 may perform a graphics pipeline for immediate mode rendering (IMR) or tile-based rendering (TBR). The expression “tile-based” means performing rendering in tile units after dividing or partitioning a frame of a moving image into a plurality of tiles. Tile-based architecture may reduce the amount of computation, compare to a case in which a frame is processed in pixel units, and may thus be a graphics rendering method used in mobile devices (or embedded devices) such as smartphones and tablet devices, which have relatively low processing performance. The structure of the shader array 110 is described below with reference to FIGS. 3 and 4.

The shader array 110 may include a plurality of shader modules (e.g., 122-1 to 122-4 in FIG. 4). The shader modules may respectively process or perform corresponding stages in a graphics pipeline. The shader module 321 (of FIG. 5) may perform vertex shading among the stages in a graphics pipeline.

According to the inventive concept, the GPU 100 may load (or offload process) input data to be processed in a graphics pipeline in at least one cycle by using the shader module 321 (of FIG. 5), which is a hardware component. For example, the GPU 100 may control the shader module 321 (of FIG. 5) to generate a search pattern for searching for and loading input data (e.g., component data) required for a specific stage (e.g., a vertex shading stage) in a graphics pipeline from the GPU memory 150. The GPU 100 may control the shader module 321 (of FIG. 5) to update the search pattern based on pipeline information, which is received from an application after the search pattern is generated. The GPU 100 may control the shader module 321 (of FIG. 5) to load the input data (e.g., component data) based on the updated search pattern and perform shading (e.g., vertex shading) on the graphics pipeline based on the loaded input data (e.g., the component data).

The GPU memory 150 may store graphics data processed by the GPU 100 or graphics data provided to the GPU 100. The GPU memory 150 may function as a working memory (e.g., cache memory) of the GPU 100. For example, the GPU memory 150 may correspond to a hardware component that stores data (e.g., primitive information, vertex information, a tile list, a display list, or frame information), which has been completely processed in the GPU 100, or provides data (e.g., data (i.e., component data) to be processed in a graphics pipeline or a tile schedule) to be processed in the GPU 100 or an internal processor.

According to some implementations, the GPU memory 150 may include first to third memories. The first memory may store pipeline information that is control information for performing a graphics pipeline received from an application. The second and third memories may store data to be processed in the graphics pipeline (i.e., input data of the graphics pipeline). For example, a data loading circuit may load the input data of the graphics pipeline from the second memory and may temporarily store the input data in the third memory (e.g., a vector register).

The display driver 600 may control a display to display an image frame rendered by the GPU 100.

The main memory 700 may include a memory array. The memory array included in the main memory 700 may correspond to random access memory (RAM), such as dynamic RAM (DRAM) or static RAM (SRAM), or a device, such as a read-only memory (ROM) device or an electrically erasable programmable ROM (EEPROM) device.

As described above, according to some implementations, the GPU 100 may prevent recompilation due to the format change of input data by loading the input data through a hardware component (i.e., the shader module 321 of FIG. 5) based on pipeline information.

Furthermore, according to the inventive concept, because the GPU 100 loads input data through a hardware component (i.e., the shader module 321 of FIG. 5) based on pipeline information, the GPU 100 may reduce compilation time and prevent excessive overload through simple code/instructions, thereby improving device performance and user experience.

FIG. 2A is a block diagram illustrating a graphics pipeline for image processing, according to some implementations.

In detail, FIG. 2A illustrates a graphics pipeline 200 that may represent a logical processing flow for performing a processing task, such as image or graphics processing. Redundant descriptions given above are omitted.

Referring to FIG. 2A, the graphics pipeline 200 may include input assembly 201, vertex shading 202, tessellation 203, geometry shading 204, rasterization 205, fragment shading 206, and color blending 207. According to some implementations, some of the stages described above may be omitted from the graphics pipeline 200, or the graphics pipeline 200 may further include a stage different from the stages described above.

Referring to FIGS. 2A and 2B, the graphics pipeline 200 may correspond to operations performed by a plurality of components 310 included in the GPU 100.

FIG. 2B illustrates components performing a graphics pipeline, according to some implementations.

In detail, FIG. 2B is a diagram illustrating a component performing each of the stages in the graphics pipeline 200 of FIG. 2A. Redundant descriptions given above are omitted.

Referring to FIG. 2B, the GPU 100 may include the plurality of components 310 performing the graphics pipeline 200 of FIG. 2A. The components 310 may perform processing operations, such as image processing operations or graphics processing operations. The components 310 may include a command processor 314, a geometry module 315, a rasterization module 316, a shader array 317 including a plurality of shader modules, and a texture module 318. In some implementations, the components 310 may include a different number or different types of modules. The texture module 318 may access a memory interface 312 through memory requests 313.

Referring to FIGS. 2A and 2B, the input assembly 201 and the tessellation 203 may be performed by the geometry module 315, the rasterization 205 may be performed by the rasterization module 316, the color blending 207 may be performed by the texture module 318, and the vertex shading 202, the geometry shading 204, and the fragment shading 206 may be performed by at least one shader module 321 included in the shader array 317.

The memory interface 312 may include at least one bus, arbiters, and/or modules performing similar functions. Software drivers included in or executed by the GPU 100 and the CPU 300 may provide commands, drawings, vertices, primitives, and/or similar inputs 311 to a graphics pipeline (i.e., the components 310).

FIG. 3 is a block diagram illustrating a shader array according to some implementations.

In detail, FIG. 3 illustrates a shader array performing a graphics pipeline (and more particular, vertex shading). Redundant descriptions given above are omitted.

Referring to FIG. 3, the GPU 100 may include a plurality of shader arrays (e.g., 120-1 and 120-2). The shader arrays (120-1 and 120-2) may share a shader input module 121. Each of the shader arrays (120-1 and 120-2) may include a plurality of shader modules and shader export modules respectively corresponding to the shader modules. For example, a first shader array 120-1 may include a first shader module 122-1, a first shader export module 123-1 corresponding to the first shader module 122-1, a second shader module 122-2, and a second shader export module 123-2 corresponding to the second shader module 122-2. A second shader array 120-2 may include a third shader module 122-3, a third shader export module 123-3 corresponding to the third shader module 122-3, a fourth shader module 122-4, and a fourth shader export module 123-4 corresponding to the fourth shader module 122-4. According to some implementations, the shader arrays (120-1 and 120-2) may be implemented in various structures.

A thread may refer to the smallest sequence of instructions that may be managed independently, and a thread block may refer to a group of threads that may be executed in series or parallel. A wave or warp may refer to a group of thread blocks that are executed simultaneously. Here, the wave may correspond to any data/element (e.g., a vertex, a pixel, or a primitive) processed by the GPU 100.

The shader input module 121 may allocate resources and may allocate waves to available wave slots of the shader modules 321 for graphics processing. A controller (341 in FIG. 5, e.g., a sequence) of the shader module 321 may schedule the execution of instructions of waves in an interleaving manner and may control the execution of instructions. For example, a processing circuit (344 in FIG. 5, e.g., a single-instruction, multiple-data (SIMD) module) may process a single instruction with respect to multiple pieces of data (e.g., data corresponding to multiple threads). In other words, the processing circuit 344 (in FIG. 5), e.g., a SIMD module, may be understood as a computation module.

When the processing of a wave is completed, the result of the processing may be transmitted to a shader export module 123-1 to 123-4 (in FIG. 3).

FIG. 4 is a diagram illustrating the structure of a shader array, according to some implementations.

In detail, FIG. 4 illustrates an example of the structure of a shader array of FIG. 3.

Referring to FIG. 4, the shader array may include a plurality of shader module group arrays. Each shader module group array may include a plurality of shader module groups. Each shader module group may include a plurality of shader modules. Here, the shader module group array may correspond to a work group processor (WGP) array, the shader module group may correspond to a WGP, and the shader module may correspond to a compute unit.

In some implementations, a first shader array may include first to N-th shader module group arrays (a total of N shader module groups).

In some implementations, the first shader module group array may include a first shader module group and a second shader module group. The first shader module group may include a first shader module 122-1 and a second shader module 122-2, and the second shader module group may include a third shader module 122-3 and a fourth shader module 122-4. The N-th shader module group array may include a first shader module group and a second shader module group. The first shader module group may include a first shader module 122-(4n-3) and a second shader module 122-(4n-2), and the second shader module group may include a third shader module 122-(4n-1) and a fourth shader module 122-4n.

The illustration of FIG. 4 is provided for convenience of description. A shader array, a shader module group array, and a shader module group may be implemented in various structures according to some implementations. The components of the shader module are described below with reference to FIG. 5.

FIG. 5 is a block diagram of a shader module according to some implementations.

Referring to FIG. 5, the shader module 321 may include a controller 341, a data address generation circuit 342, a data loading circuit 343, and a processing circuit 344. For example, the shader module 321 may correspond to a compute unit (CU). The controller 341 may correspond to a sequencer. The data address generation circuit 342 may correspond to a texture address generation circuit, the data loading circuit 343 may correspond to a texture data path, and the processing circuit 344 may correspond to a SIMD circuit.

In some implementations, the controller 341 may decode an instruction for execution of the GPU 100 and issue OP code obtained by converting the decoded instruction into an assembly-level instruction (machine language). In other words, the controller 341 may correspond to a control circuit that decodes the instruction for the execution of the GPU 100 and schedules the decoded instruction.

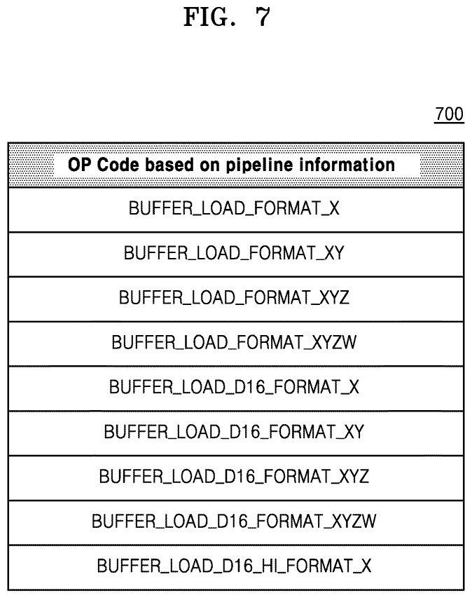

In some implementations, when receiving an instruction for performing a graphics pipeline, the controller 341 may read pipeline information for the execution (e.g., vertex shading) of the GPU 100 from a GPU memory and may issue/transmit OP code (see FIG. 7) to the data address generation circuit 342 based on the pipeline information. Here, the pipeline information may be received from an application whenever the graphics pipeline is performed and may correspond to control information for the GPU 100 (e.g., a GPU core). The pipeline information may include format information of at least one piece of input data, offset information for searching for at least one piece of input data, stride information, and data type information (e.g., dword information (32 bits)) for shading (e.g., vertex shading). Components (e.g., the controller 341, the data address generation circuit 342, and the data loading circuit 343) included in the shader module 321 may read the pipeline information from the GPU memory when necessary and may operate according to the pipeline information that has been read. The controller 341 may decode the instruction for performing the graphics pipeline and the pipeline information, identify the format of the input data, and issue/transmit the OP code (see FIG. 7) corresponding to the identified format to the data address generation circuit 342. At this time, a COMP_ALIGNMENT_MODE field may be added to a buffer command (e.g., the OP code) transmitted from the processing circuit 344 to the data address generation circuit 342 via the controller 341. The controller 341 may indicate whether input data is loaded in multiple cycles (i.e., component_alignment multi-cycling) by storing (or mirroring) a value stored in the COMP_ALIGNMENT_MODE field of a CONFIG buffer in the COMP_ALIGNMENT_MODE field of the buffer command (e.g., the OP code) and transmitting the value to the data address generation circuit 342. Here, the CONFIG buffer may store setting values required for the shading of the GPU 100. For example, when “1” is stored in the COMP_ALIGNMENT_MODE field of the buffer command (e.g., the OP code) transmitted from the processing circuit 344 to the data address generation circuit 342, this may indicate that input data is loaded in multiple cycles. When “0” is stored in the COMP_ALIGNMENT_MODE field, this may indicate that input data is not loaded in multiple cycles. Here, when “1” is stored in the COMP_ALIGNMENT_MODE field of the buffer command (e.g., the OP code), that is, when input data is loaded in multiple cycles, the memory address of the input data may not satisfy the minimum alignment condition. The minimum alignment condition may refer to a condition in which the memory address (e.g., element address) of input data should be aligned to a minimum size (e.g., element size or dword). For example, 8_8_8_8 format may satisfy the minimum alignment condition when aligned to an element size (i.e., 32 bits).

In some implementations, the data address generation circuit 342 may receive an instruction (e.g., OP code) from the controller 341.

In some implementations, the data address generation circuit 342 may store a lookup table of comp_align_size for each format of input data. Here, the data address generation circuit 342 may determine the format of input data according to the type (e.g., a TBUFFER_LOAD command or a BUFFER_LOAD command) of instruction (e.g., OP code). For example, when the TBUFFER_LOAD command is received as the OP code, the data address generation circuit 342 may determine the format of input data based on an instruction. For example, when the BUFFER_LOAD command is received as the OP code, the data address generation circuit 342 may determine the format of input data based on pipeline information.

In some implementations, when the memory address of input data does not satisfy the minimum alignment condition, the data address generation circuit 342 may generate a memory address enabling the input data to be loaded in multiple cycles (i.e., component_alignment multi-cycling). In other words, the data address generation circuit 342 may identify comp_align_size corresponding to the format of input data, which is determined using a lookup table, and may generate a memory address for loading the input data based on the identified comp_align_size. For example, when the identified comp_align_size is 32 bits, the data address generation circuit 342 may generate a memory address such that 32 bits of component data are loaded per cycle (i.e., multi-cycle loading is performed). For example, when the identified comp_align_size is 16 bits, the data address generation circuit 342 may generate a memory address such that 16 bits of component data (at least part of input data) are loaded per cycle (i.e., multi-cycle loading is performed). For example, when the identified comp_align_size is 8 bits, the data address generation circuit 342 may generate a memory address such that 8 bits of component data (at least part of input data) are loaded per cycle (i.e., multi-cycle loading is performed).

In some implementations, the data address generation circuit 342 may generate a search pattern for searching the second memory of the GPU memory (refer to FIG. 1) for input data and generate a memory address based on the search pattern.

In some implementations, when receiving OP code after generating a search pattern, the data address generation circuit 342 may identify the format of input data, which is input to a graphics pipeline (e.g., the shader module 321), based on the OP code (or pipeline information).

In some implementations, the data address generation circuit 342 may identify a change in the format of input data by comparing the format of current input data of OP code (or pipeline information) with the format of previous input data. When the format of input data has been changed, the data address generation circuit 342 may update a search pattern based on the received pipeline information. For example, the data address generation circuit 342 may update a memory address for starting a search for the input data in the second memory of the GPU memory (refer to FIG. 1), based on offset information among the pipeline information. For example, the data address generation circuit 342 may update a search unit for the input data in the search pattern, based on stride information among the pipeline information.

In some implementations, the data address generation circuit 342 may generate the memory address (e.g., a second memory address) of the input data based on the updated search pattern and may transmit the memory address to the data loading circuit 343.

In some implementations, a field indicating that the data address generation circuit 342 is engaged in an operation (i.e., component_alignment multi-cycling) of loading input data in multiple cycles may be added to a first-in, first-out (FIFO) register of the data address generation circuit 342 and/or the data loading circuit 343.

In some implementations, the data loading circuit 343 may load data (i.e., input data) corresponding to a memory address from the second memory of the GPU memory (refer to FIG. 1) by referring to the memory address generated by the data address generation circuit 342. For example, the data loading circuit 343 may load data (i.e., at least part of the input data) stored in the memory address received from the data address generation circuit 342 and may store the data in the third memory of the GPU memory (refer to FIG. 1). Here, the third memory of the GPU memory may correspond to a vector register.

In some implementations, the data loading circuit 343 may pad and store input data according to a method (e.g., zero padding) determined in advance based on data type information among the pipeline information. For example, when the OP code is BUFFER_LOAD_D16_FORMAT_XYZ, the input data may include component data X, Y, and Z. In this case, the data loading circuit 343 may generate first padded data (in dword format) of a total of 32 bits by adding (zero padding) 16 bits of zero in front of component data X (16 bits) and may store the first padded data in a first vector register. The data loading circuit 343 may generate second padded data (in dword format) of a total of 32 bits by adding (zero padding) 16 bits of zero in front of component data Y (16 bits) and may store the second padded data in a second vector register. The data loading circuit 343 may generate third padded data (in dword format) of a total of 32 bits by adding (zero padding) 16 bits of zero in front of component data Z (16 bits) and may store the third padded data in a third vector register. According to some implementations, the data loading circuit 343 may pad component data based on zero padding and other various padding methods. The first to third vector registers may be different from one another.

In some implementations, the processing circuit 344 may perform operations by applying a single instruction to multiple pieces of data in parallel. For example, a wave is typically composed of 32 threads, and the processing circuit 344 may execute the same instruction for each thread of the wave simultaneously. The processing circuit 344 may process various commands of a shader program, such as arithmetic operations, logical operations, conditional branching, and texture result processing.

In some implementations, the processing circuit 344 may receive at least one piece of padded data (e.g., first to third padded data) stored in the third memory (i.e., the vector register) and may perform shading based on the at least one piece of padded data (e.g., the first to third padded data). Here, shading may include vertex shading in a graphics pipeline.

As described above, according to some implementations, the shader module 321 may prevent recompilation due to the format change of input data by loading input data (in multiple cycles) based on pipeline information.

Furthermore, by loading input data based on pipeline information, the shader module 321 may reduce compilation time and prevent excessive overload through simple code/instructions, thereby improving device performance and user experience.

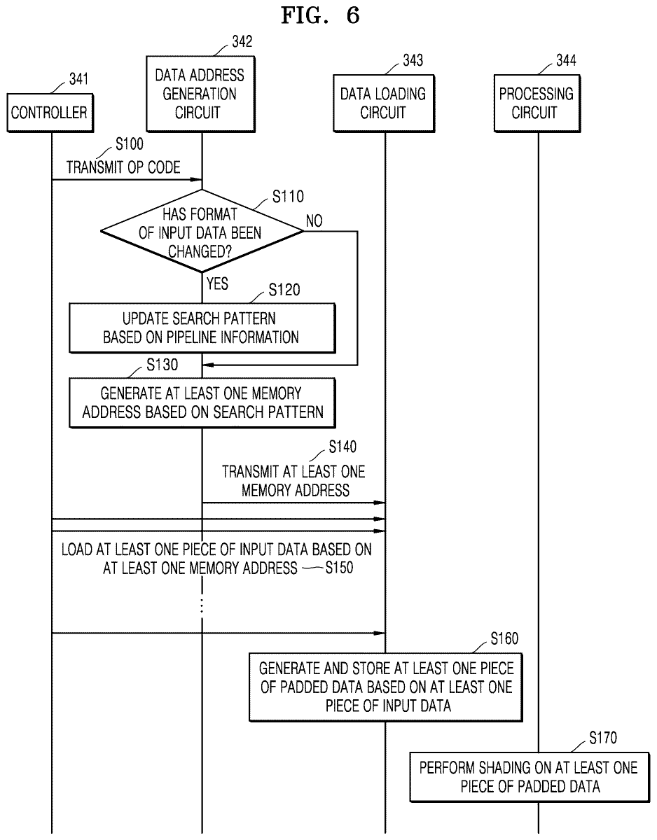

FIG. 6 is a flowchart of an operating method of a GPU, according to some implementations.

In detail, an example of a method of loading (multi-cycle loading) input data of a graphics pipeline based on the shader module 321 (i.e., a hardware module) is described from the perspective of each device with reference to FIG. 6. The controller 341, the data address generation circuit 342, the data loading circuit 343, and the processing circuit 344 in FIG. 6 may respectively correspond to the controller 341, the data address generation circuit 342, the data loading circuit 343, and the processing circuit 344 in FIG. 5. Redundant descriptions given above are omitted.

In FIG. 6, it is assumed that the address (e.g., element address) of input data to be processed in the graphics pipeline does not satisfy the minimum alignment condition. According to some implementations, the GPU 100 may load the input data in multiple cycles by using the shader module 321. The specific operations of the shader module 321 are described below.

Referring to FIG. 6, a method of loading, by the shader module 321 (a hardware component) of the GPU 100, input data of a graphics pipeline may include operations S100 to S170. According to some implementations, the shader module 321 may include the controller 341, the data address generation circuit 342, the data loading circuit 343, and the processing circuit 344.

The controller 341 may transmit OP code for performing a graphics pipeline to the data address generation circuit 342 in operation S100. For example, the controller 341 may receive an instruction for performing the graphics pipeline and convert the instruction into assembly-level OP code based on pipeline information. The OP code generated by converting the instruction may correspond to format information of input data included in the pipeline information. The controller 341 may transmit the OP code to the data address generation circuit 342.

Based on the OP code and the pipeline information, the data address generation circuit 342 may identify whether the format of at least one piece of input data is changed in operation S110. The data address generation circuit 342 may determine whether to identify the format of at least one piece of input data, based on the OP code and the pipeline information. For example, when receiving the TBUFFER_LOAD command as the OP code, the data address generation circuit 342 may determine the format of at least one piece of input data based on the instruction. For example, when receiving the BUFFER_LOAD command as the OP code, the data address generation circuit 342 may determine the format of at least one piece of input data based on the pipeline information. In FIG. 6, it is assumed that the format of at least one piece of input data is determined based on the pipeline information. The data address generation circuit 342 may determine the format of at least one current piece of input data, based on format information of at least one piece of input data included in the pipeline information. The data address generation circuit 342 may identify whether the format of at least one piece of input data is changed by comparing the format of at least one current piece of input data with the format of at least one previous piece of input data. When the format of at least one piece of input data has been changed, the data address generation circuit 342 may perform operation S120. Otherwise, when the format of at least one piece of input data has not been changed, the data address generation circuit 342 may skip operation S120.

When the format of at least one piece of input data has been changed, the data address generation circuit 342 may update a search pattern for the at least one piece of input data by using the pipeline information in operation S120. The pipeline information may include format information of the at least one piece of input data, offset information for searching for the at least one piece of input data, stride information, and data type information (e.g., dword information (e.g., 32 bits) for shading. The pipeline information may be stored in the GPU memory (e.g., the first memory) of the GPU 100. For example, the data address generation circuit 342 may update a memory address for starting a search for the at least one piece of input data in the search pattern, based on the offset information among the pipeline information. For example, the data address generation circuit 342 may update a search unit for the at least one piece of input data in the search pattern, based on the stride information among the pipeline information.

The data address generation circuit 342 may generate at least one memory address corresponding to the at least one piece of input data based on the search pattern in operation S130. For example, the data address generation circuit 342 may generate the at least one memory address corresponding to the at least one piece of input data in the GPU memory (e.g., the second memory), based on the search pattern updated in operation S120.

The data address generation circuit 342 may transmit the at least one memory address to the data loading circuit 343 in operation S140.

The data loading circuit 343 may load at least one piece of input data (in multiple cycles) based on the at least one memory address in operation S150. The at least one piece of input data may have been stored in the GPU memory (e.g., the second memory). The data loading circuit 343 may read data corresponding to each of the at least one memory address from the GPU memory (e.g., the second memory), thereby loading at least one piece of input data. For example, the data loading circuit 343 may load one piece of component data (i.e., a part of the at least one piece of input data) per cycle, thereby loading the at least one piece of input data in multiple cycles. The size of component data loaded per cycle may be determined according to Comp_align_size for each format of input data by referring to a lookup table showing the correspondence between the format of input data and Comp_align_size. For example, when the format of input data is “8_8_8_8_UINT”, Comp_align_size is assumed to be 8 bits. In this case, the data loading circuit 343 may load one piece of component data of 8 bits per cycle.

The data loading circuit 343 may generate at least one piece of padded data based on the at least one piece of input data, which has been loaded, in operation S160. For example, the data loading circuit 343 may pad the at least one piece of input data according to a predetermined method, based on the data type information (e.g., dword information (32 bits)), thereby generating at least one piece of padded data. The data loading circuit 343 may store the at least one piece of padded data in the GPU memory (e.g., the third memory (i.e., the vector register)).

The processing circuit 344 may perform shading (e.g., vertex shading) on the at least one piece of padded data stored in the GPU memory (e.g., the third memory (i.e., the vector register)) in operation S170.

As described above, according to the inventive concept, a GPU may load input data (e.g., component data of a graphics pipeline) through a hardware component (i.e., the shader module 321) based on pipeline information, thereby preventing recompilation due to the format change of the input data.

Furthermore, according to the inventive concept, because a GPU loads input data through a hardware component based on pipeline information, the GPU may reduce compilation time and prevent excessive overload through simple code/instructions, thereby improving device performance and user experience.

FIG. 7 shows examples of instructions based on pipeline information, according to some implementations. Redundant descriptions given above are omitted.

In detail, FIG. 7 shows an example 700 of OP code resulting from the conversion by the controller 341 in FIG. 6.

The OP code of FIG. 7 may correspond to an assembly-level instruction for loading input data (e.g., component data) from a GPU memory in order to perform shading (e.g., vertex shading) in a graphics pipeline. For example, the OP code for loading input data (e.g., component data) to be processed in the graphics pipeline may be BUFFER_LOAD_FORMAT_X, BUFFER_LOAD_FORMAT_XY, BUFFER_LOAD_FORMAT_XYZ, BUFFER_LOAD_FORMAT_XYZW, BUFFER_LOAD_D16_FORMAT_X, BUFFER_LOAD_D16_FORMAT_XY, BUFFER_LOAD_D16_FORMAT_XYZ, BUFFER_LOAD_D16_FORMAT_XYZW, or BUFFER_LOAD_D16_HI_FORMAT_X.

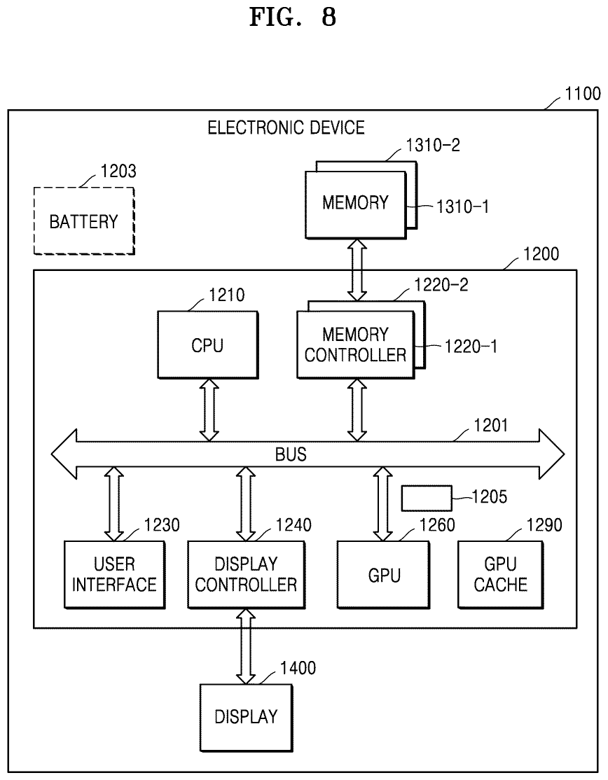

FIG. 8 is a block diagram of an electronic device according to some implementations. Redundant descriptions given above are omitted.

Referring to FIG. 8, an electronic device 1100 may include a TV (e.g., a digital TV or a smart TV), a PC, a desktop computer, a laptop computer, a computer workstation, a tablet PC, a video game platform (or a video game console), a server, or a portable electronic device.

The portable electronic device may include a mobile phone, a smartphone, a PDA, an EDA, a digital still camera, a digital video camera, a PMP, a PND, an MID, a wearable computer, an IoT device, an IoE device, or an e-book.

The electronic device 1100 may include various devices that process and display 2D or 3D graphics data. The electronic device 1100 may include an SoC 1200, one or more memories (e.g., 1310-1 and 1310-2), and a display 1400.

The SoC 1200 may function as a host of the electronic device 1100. The SoC 1200 may generally control operations of the electronic device 1100. For example, the SoC 1200 may be replaced with an integrated circuit (IC), an application processor (AP), or a mobile AP, which may load input data to be processed in a graphics pipeline in multiple cycles by controlling the shader module 321 (i.e., a hardware component) when the address of the input data to be processed in the graphics pipeline does not satisfy the minimum alignment condition. The SoC 1200 in FIG. 8 may correspond to the SoC 10 of FIG. 1.

A CPU 1210, one or more memory controllers (e.g., 1220-1 and 1220-2), a user interface 1230, a display controller 1240, and a GPU 1260 may communicate with one another through a bus 1201. The CPU 1210 in FIG. 8 may correspond to the CPU 300 in FIG. 1.

For example, the bus 1201 may include a peripheral component interconnect (PCI) bus, a PCI express bus, advanced microcontroller bus architecture (AMBA), an advanced high-performance bus (AHB), an advanced peripheral bus (APB), an advanced extensible interface (AXI) bus, or a combination thereof.

The CPU 1210 may control operations of the SoC 1200. According to some implementations, the CPU 1210 may determine (calculate or measure) at least one property (or characteristic) of the electronic device 1100, may select one of a plurality of addresses of a plurality of memory areas of a first memory 1310-1, which stores a plurality of already prepared models, based on the result of the determination (the calculation or the measurement), and may transmit the selected address to the GPU 1260. The GPU 1260 in FIG. 8 may correspond to the GPU 100 in FIG. 1.

When the electronic device 1100 is a portable electronic device, the electronic device 1100 may include a battery 1203 for internal power supply.

A user may provide an input to the SoC 1200 such that the CPU 1210 may execute one or more applications (e.g., software applications).

The applications executed by the CPU 1210 may include an OS, a word processor application, a media player application, a video game application, and/or a graphical user interface (GUI) application.

A user may enable an input to be input to the SoC 1200 through an input device (not shown) connected to the user interface 1230. For example, the input device may include a keyboard, a mouse, a microphone, or a touch pad.

The applications executed by the CPU 1210 may include graphics rendering instructions. The graphics rendering instructions may be related to a graphics API.

The graphics API may refer to OpenGL(R) API, Open GL ES API, DirectX API, Renderscript API, WebGL API, or Open VG(R) API.

To process the graphics rendering instructions, the CPU 1210 may transmit a graphics rendering command to the GPU 1260 through the bus 1201. Accordingly, the GPU 1260 may process (or render) graphics data in response to the graphics rendering command.

The graphics data may include points, lines, triangles, quadrilaterals, patches, and/or primitives. The graphics data may also include line segments, elliptical arcs, quadratic Bezier curves, and/or cubic Bezier curves.

One or more memory controllers (1220-1 and 1220-2) may read data (e.g., graphics data) from one or more memories (1310-1 and 1310-2) in response to a read request from the CPU 1210 or the GPU 1260 and may transmit the read data (e.g., the graphics data) to a corresponding component (e.g., 1210, 1240, or 1260).

According to some implementations, the SoC 1200 may include a hardware component 1205 that may load at least one piece of input data (e.g., component data) to be input for a shading (e.g., vertex shading) process in a graphics pipeline in multiple cycles. Here, the hardware component 1205 may correspond to the shader module 321 of FIG. 5. The hardware component 1205 may include the controller 341, the data address generation circuit 342, the data loading circuit 343, and the processing circuit 344. Although it is illustrated in FIG. 8 that the hardware component 1205 is separate from the GPU 1260 for convenience of description, implementations are not limited thereto. According to some implementations, the hardware component 1205 may be implemented as an internal component of the GPU 1260.

According to some implementations, the hardware component 1205 (e.g., the shader module 321 of FIG. 5) may identify whether the format of at least one piece of input data is changed based on pipeline information.

According to some implementations, when the format of at least one piece of input data has been changed, the hardware component 1205 may update a search pattern for searching for and loading the at least one piece of input data by using the pipeline information. The hardware component 1205 (e.g., the shader module 321 of FIG. 5) may update a memory address for starting a search for the at least one piece of input data in the search pattern, based on offset information among the pipeline information. The hardware component 1205 (e.g., the shader module 321 of FIG. 5) may also update a search unit for the at least one piece of input data in the search pattern, based on stride information among the pipeline information.

According to some implementations, the hardware component 1205 may load the at least one piece of input data in multiple cycles based on the updated search pattern. For example, the hardware component 1205 may generate the memory address of the at least one piece of input data that corresponds to the updated search pattern. The hardware component 1205 may load the at least one piece of input data by reading data stored at the memory address. At this time, the hardware component 1205 may pad the at least one piece of input data according to a predetermined method (e.g., zero padding) based on data type information (e.g., dword information (32 bits)) among the pipeline information and may perform shading (e.g., vertex shading) on the at least one piece of padded input data. Here, the pipeline information may include format information of the at least one piece of input data, offset information for searching in the memory (1310-1 or 1310-2) for the at least one piece of input data, stride information, and data type information for shading.

In response to a write request output from the CPU 1210 or the GPU 1260, one or more memory controllers (1220-1 and 1220-2) may write data (e.g., graphics data), which is output from a corresponding component (e.g., 1210, 1230, or 1240), to one or more memories (1310-1 and 1310-2). One or more memories (1310-1 and 1310-2) in FIG. 8 may correspond to the main memory 700 in FIG. 1.

Although it is illustrated in FIG. 8 that one or more memory controllers (1220-1 and 1220-2) are separate from the CPU 1210 or the GPU 1260 for convenience of description, one or more memory controllers (1220-1 and 1220-2) may be implemented inside the CPU 1210, the GPU 1260, or the one or more memories (1310-1 and 1310-2).

According to some implementations, when the first memory 1310-1 is volatile memory and a second memory 1310-2 is non-volatile memory, a first memory controller 1220-1 may communicate with the first memory 1310-1 and a second memory controller 1220-2 may communicate with the second memory 1310-2.

For example, the volatile memory may include RAM, SRAM, DRAM, synchronous DRAM (SDRAM), thyristor RAM (T-RAM), zero-capacitor RAM (Z-RAM), or twin transistor RAM (TTRAM).

The non-volatile memory may include EEPROM, flash memory, magnetic RAM (MRAM), spin-transfer torque MRAM, ferroelectric RAM (FeRAM), phase-change RAM (PRAM), or resistive RAM (RRAM).

The non-volatile memory may be implemented in a multimedia card (MMC), an embedded MMC (eMMC), universal flash storage (UFS), a solid state drive (SSD), or a universal serial bus (USB) flash drive.

One or more memory controllers (1220-1 and 1220-2) may store programs (or applications) or instructions, which are executable by the CPU 1210. One or more memory controllers (1220-1 and 1220-2) may also store data to be used by a program executed by the CPU 1210.

One or more memory controllers (1220-1 and 1220-2) may also store a user application and graphics data related to the user application. One or more memory controllers (1220-1 and 1220-2) may also store data (or information) to be used by components included in the SoC 1200 or data (or information) that has been generated by the components.

One or more memory controllers (1220-1 and 1220-2) may store data to be used for the operation of the GPU 1260 and/or data generated by the operation of the GPU 1260. The one or more memory controllers (1220-1 and 1220-2) may store command streams for the processing of the GPU 1260.

The display controller 1240 may transmit data processed by the CPU 1210 or data (e.g., graphics data) processed by the GPU 1260 to the display 1400. The display controller 1240 in FIG. 8 may correspond to the display driver 600 in FIG. 1.

The display 1400 may include a monitor, a TV monitor, a projection device, a thin-film transistor-liquid crystal display (TFT-LCD), a light-emitting diode (LED) display, an organic LED (OLED) display, an active-matrix OLED (AMOLED) display, or a flexible display.

According to some implementations, the display 1400 may be integrated (or embedded) in the electronic device 1100. For example, the display 1400 may correspond to the screen of a portable electronic device and may be a stand-alone device connected to the electronic device 1100 through a wireless communication link or a wired communication link.

According to some implementations, the display 1400 may correspond to a computer monitor connected to a PC through a cable or a wired link.

The GPU 1260 may receive commands from the CPU 1210 and may execute the commands. The commands executed by the GPU 1260 may include a graphics command, a memory transmission command, a kernel execution command, a tessellation command, and/or a texturing command.

The GPU 1260 may perform graphics operations to render graphics data.

When an application running on the CPU 1210 requests graphics processing, the CPU 1210 may transmit graphics data and a graphics command to the GPU 1260 such that the graphics data is rendered on the display 1400.

The graphics command may include a tessellation command and/or a texturing command. The graphics data may include vertex data, texture data, or surface data.

A surface may include a parametric surface, a subdivision surface, a triangle mesh, or a curve.

According to some implementations, the CPU 1210 may transmit a graphics command and graphics data to the GPU 1260. According to some implementations, when the CPU 1210 writes a graphics command and graphics data to one or more memories (1310-1 and 1310-2), the GPU 1260 may read the graphics command and the graphics data from one or more memories (1310-1 and 1310-2).

The GPU 1260 may directly access a GPU cache 1290. Accordingly, the GPU 1260 may write graphics data to or read graphics data from the GPU cache 1290 without going through the bus 1201. The GPU cache 1290 may be an example of GPU memory that may be accessed by the GPU 1260.

Although the GPU 1260 is separated from the GPU cache 1290 in FIG. 8, the GPU 1260 may include the GPU cache 1290. For example, the GPU cache 1290 may include DRAM or SRAM.

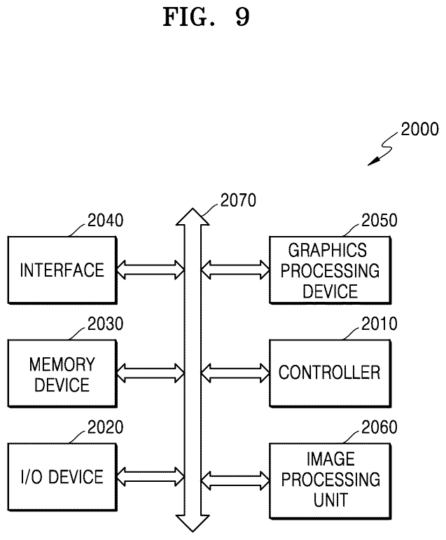

FIG. 9 illustrates an electronic device according to some implementations.

In detail, FIG. 9 illustrates an electronic device 2000 including a graphics processing device 2050, according to some implementations. The graphics processing device 2050 in FIG. 9 may correspond to the GPU 100 in FIGS. 1 to 8.

When the address of input data to be processed in a graphics pipeline does not satisfy the minimum alignment condition, the graphics processing device 2050 may update a search pattern for loading the input data, based on pipeline information. The graphics processing device 2050 may load the input data in multiple cycles based on the updated search pattern and may store the input data in a vector register. The graphics processing device 2050 may perform shading (e.g., vertex shading) on the loaded input data.

The electronic device 2000 may include a controller 2010, an input/output (I/O) device 2020, such as a keypad, a keyboard, a display, a touch screen display, a camera, and/or an image sensor, a memory device 2030, an interface 2040, the graphics processing device 2050, and an image processing unit 2060, which are a connected to each other via a bus 2070. The memory 2030 may store command code used by the controller 2010, graphics data, or pipeline information.

As described above, according to the inventive concept, the graphics processing device 2050 of the electronic device 2000 may prevent recompilation due to the format change of input data by loading the input data of a graphics pipeline through a hardware component (e.g., the shader module 321 of FIG. 5) based on the pipeline information.

Furthermore, according to the inventive concept, because the graphics processing device 2050 of the electronic device 2000 loads input data through a hardware component (e.g., the shader module 321 of FIG. 5) based on pipeline information, the graphics processing device 2050 may reduce compilation time and prevent excessive overload through simple code/instructions, thereby improving device performance and user experience.

While the inventive concept has been particularly shown and described with reference to implementations thereof, it will be understood that various changes in form and details may be made therein without departing from the spirit and scope of the following claims.

What is claimed is:

1. A graphics processing unit (GPU) comprising:
a GPU memory comprising a first memory and a second memory; and
a plurality of shader arrays each comprising a plurality of shader modules,
wherein each shader module of the plurality of shader modules comprises:
a data address generation circuit configured to, (i) based on pipeline information stored in the first memory, update a search pattern for at least one piece of input data and, (ii) based on an updated search pattern, generate at least one memory address corresponding to the at least one piece of input data,
a data loading circuit configured to load the at least one piece of input data from the second memory, based on the at least one memory address and the pipeline information,
a controller configured to schedule at least one instruction for performing a graphics pipeline, and
a processing circuit configured to perform shading on the at least one piece of input data.

2. The GPU of claim 1, wherein
the pipeline information comprises (i) format information of the at least one piece of input data, (ii) offset information, (iii) stride information, and (iv) data type information related to the shading, and
the data address generation circuit is configured to locate the at least one piece of input data within the second memory based on the offset information.

3. The GPU of claim 2, wherein
the data address generation circuit is configured to:
receive operation (OP) code from the controller;
identify a change of a format of the at least one piece of input data based on the pipeline information and the OP code; and
update, based on the format of the at least one piece of input data being changed, the search pattern based on the pipeline information.

4. The GPU of claim 2, wherein,
the data address generation circuit is configured to:
update a memory address of the second memory in the search pattern based on the offset information; and
update the search pattern based on an updated memory address of the second memory in the search pattern.

5. The GPU of claim 3, wherein
the data address generation circuit is configured to:
update a search unit for the at least one piece of input data in the search pattern, based on the stride information; and
update the search pattern based on an updated search unit for the at least one piece of input data in the search pattern.

6. The GPU of claim 2, wherein
the GPU memory comprises a third memory, and
the data loading circuit is configured to store the at least one piece of input data in the third memory, the at least one piece of input data being loaded from the second memory.

7. The GPU of claim 6, wherein
the data loading circuit is configured to (i) generate, based on the data type information, at least one piece of padded data by padding the at least one piece of input data according to a predetermined method, and (ii) store the at least one piece of padded data in the third memory, and
the processing circuit is configured to perform the shading on the at least one piece of padded data stored in the third memory.

8. The GPU of claim 1, wherein the shading comprises vertex shading in the graphics pipeline.

9. An operating method of a graphics processing unit (GPU), the operating method comprising:
identifying a change of a format of at least one piece of input data based on pipeline information and operation (OP) code;
updating a search pattern for the at least one piece of input data by using the pipeline information, based on the format of the at least one piece of input data being changed;
loading the at least one piece of input data based on the search pattern that has been updated; and
performing shading on the at least one piece of input data that has been loaded.

10. The operating method of claim 9, wherein
the pipeline information comprises (i) format information of the at least one piece of input data, (ii) offset information used to locate the at least one piece of input data, (iii) stride information, and (iv) data type information related to the shading.

11. The operating method of claim 10, wherein updating the search pattern comprises:
updating a memory address in the search pattern, based on the offset information, the memory address being used to start a search for the at least one piece of input data.

12. The operating method of claim 10, wherein updating the search pattern comprises:
updating a search unit for the at least one piece of input data in the search pattern, based on the stride information.

13. The operating method of claim 9, comprising:
based on the search pattern that has been updated, generating at least one memory address corresponding to the at least one piece of input data in a memory of the GPU.

14. The operating method of claim 13, wherein loading the at least one piece of input data comprises:
reading data corresponding to the at least one memory address and loading the at least one piece of input data.

15. The operating method of claim 10, comprising:
generating, based on the data type information, at least one piece of padded data by padding the at least one piece of input data according to a predetermined method; and
performing the shading on the at least one piece of padded data.

16. The operating method of claim 9, wherein the shading comprises vertex shading in the graphics pipeline.

17. An electronic device comprising:
a memory; and
a processor comprising a shader module configured to perform a graphics pipeline,
wherein the shader module is configured to perform the graphics pipeline based on:
updating a search pattern for at least one piece of input data based on pipeline information,
loading the at least one piece of input data in multiple cycles based on the search pattern that has been updated,
padding the at least one piece of input data according to a predetermined method, based on the pipeline information, and
performing shading on the at least one piece of input data that has been padded.

18. The electronic device of claim 17, wherein
the pipeline information comprises (i) format information of the at least one piece of input data, (ii) offset information, (iii) stride information, and (iv) data type information related to the shading, and
the shader module is configured to locate the at least one piece of input data based on the offset information.

19. The electronic device of claim 18, wherein
the shader module is configured to:
update a memory address of the memory based on the offset information; and
update the search pattern based on an updated memory address of the memory in the search pattern.

20. The electronic device of claim 18, wherein
the shader module is configured to:
update a search unit for the at least one piece of input data in the search pattern based on the stride information; and
update the search pattern based on an updated search unit.
